(19) United States
(12) Patent Application Publication
(10) Pub. No.: US 2004/0237845 A1
(43) Pub. Date: Dec. 2, 2004

(54) Stabilized chlorine dioxide as oxidizing agent for use in pulp

(76) Inventor: Alan Hunton, (US)

Correspondence Address: Glenna Hendricks, Esq., P.O. Box 2509, Fairfax, VA, 22031-2509, US

(21) Appl. No.: 10/294,889

(22) Filed: Nov. 15, 2002

(51) Int. Cl. C04B 14/04

(52) U.S. Cl. 106/488; 252/186.1; 252/187.21

(57) ABSTRACT

This invention provides improved kaolin clay slurries by processes for addition of stabilized chlorine dioxide which oxidizes organic impurities, including living organisms and organic debris, to kaolin clays and bleaching agents used in the paper-making industry.

### FIELD AND BACKGROUND OF THE INVENTION

This invention is related to means for oxidizing organic contaminants and destroying microorganisms in kaolin clay slurry and other materials for use in production of paper from pulp.

Sodium Chlorite (also known as stabilized chlorine dioxide) is most often available commercially in an aqueous concentrate with the chlorite content 4 to 35% weight. The sodium chlorite solutions man contain other inorganic salts which are present in minor proportions. The sodium chlorite in such formulations is the precursor of chlorine dioxide. The chlorine dioxide is a potent oxidizing agent and biocide. The chlorine dioxide is released when the chlorite is in contact with acids or chlorine donors.

Chlorite solutions are often sold as “stabilized chlorine dioxide” from which the chlorine dioxide is released upon addition of acid.

Kaolin clays as used in pulping is not widely dispersed in nature. The major deposits of kaolin clay in North America are found in Georgia. Kaolin clay used in slurries, often known as kaolinite slurry, are usually derived from alluvial soil or may be mined. The kaolin slurry usually contains from 50% to 75% solid clay in water. The pH of kaolin slurries usually ranges from 6 to 9.5. The raw kaolin contains impurities and some of these impurities will remain in the clay slurry product after processing, including quartz sand, feldspar minerals, other aluminosilicates, and mineral oxides and carbonates. These trace impurities do not interfere with the process of using the kaolin clays in making paper. (However, such impurities are abrasive and this quality presents a disadvantage to the end user.) Clay may be processed to remove impurities and packaged either as a solid clay product for shipment or may be transported to the end-user as a slurry for immediate use.

Raw hydrous kaolin clay (Al₂(OH)₅SiO₅), also known as hydrous aluminum silicate, washed kaolin clays and calcined kaolin clays (sometimes known as calcinated china clay) are all used in slurry form. Calcinated clays which have been processed at high temperatures are a particularly useful form of kaolin clay. Sometimes small amounts of titanium dioxide are added to a kaolin slurry to obtain desirable properties in the paper produced.

Kaolin is processed by mixing the crude clay with water containing dispersants (e.g. polyacrylates) and pH modifiers (i.g. alkalies). The mixed aqueous clay is degritted by gravity processes, treated with acid and reductive bleaches (for example, sodium bisulfite) and dewatered to the desired concentration by filtration. The clay is acidic in the filtration stage. The suspension is again made alkaline after filtration and additional dispersants are added. The clay products are often treated by addition of biocides.

Sources of contamination by microorganisms may be the crude clay, the water, pipe work, storage tanks, etc. Anaerobic bacteria may be present in the bottom of tanks and may give rise to hydrogen sulphide formation. Iron sulphide may be formed, causing grayish discoloration of the clay. Use of a strong oxidizing agent is required to remove the gray color. Although calcinated clays are less likely to be discolored (calcination removes sulphur compounds) it is still possible for calcinated clays to be contaminated with microorganisms.

Clay as a slurry is often transferred from storage tanks to tankers for transportation to distribution points or to the end-user. It is the responsibility of the clay producer to ensure that the clay is maintained at high quality during transportation until delivery. Biocides used in the slurry must be sufficient to remove existing organisms and to prevent recontamination during transport. Organic biocides such which provide medium to long term protection to the slurry are usually added prior to shipment. Some of the more commonly used biocides are tetrahydro-3,5-dimethyl-2H-1,3,5-thiodiazine-2-thione (thione), 1,2 benzisothiazolein-3-one (BIT), 5-chloro-2-methyl-4-isothaoline-3-one (Kathon™) and glutaraldehyde. These organic biocides have several disadvantages. Some are potentially harmful to humans and may be somewhat persistent. Many are incompatible with use of hydrogen peroxide or chlorine. Many are degraded by sulphites and other reductants or are deactivated by ammonia/amines. It is known that the most potent biocidal and oxidizing properties of stabilized chlorine dioxide are derived from the release of free chlorine dioxide. (Sodium chlorite does have biocidal and oxidizing activity.)

Other mineral slurries such as those containing titanium or ground calcium carbonate are sometimes used in place of kaolin clay in making paper.

There have previously been attempts to add stabilized chlorine dioxide to kaolin slurry. However, prior methods have some disadvantages over the processing methods disclosed herein.

### SUMMARY OF THE INVENTION

It is the purpose of this invention to provide improved kaolin clay slurry by providing processes for addition of stabilized chlorine dioxide for purposes of oxidizing organic impurities, including living organisms and organic debris, to kaolin clays and bleaching agents used in the paper-making industry.

### DETAILED DESCRIPTION OF THE INVENTION

It has now been found that addition of stabilized chlorine dioxide to kaolin clay slurry, under appropriate conditions, (without further addition of acid or chlorine donor) results in slow release of free chlorine dioxide. The presence of free ClO₂ was evidenced by the appearance of a yellow color to the water phase. It was also unexpectedly found that the ClO₂ persisted for several days in slurry. Hence the oxidizing/biocidal effects persist for up to 14 days, thus providing protection from contamination during shipping.

Attempts have been made to add chlorite to the slurry after it has passed the production line. However, problems were encountered when the chlorite was weighed out and added to the clay slurry. This can result in an explosion. The problems related thereto have been overcome by adding the chlorite as a solution from a dosing regulatory system during continued agitation of the slurry. In the usual instance, the kaolin clay slurry having a pH in the range of 6-9 is prepared, then transferred to a holding tank. It has been found that the handling risks associated with sodium chlorite are minimized if the chlorite is transferred to the tanks via a dedicated dosing line and the slurry in the tanks is agitated continuously. The chlorite-containing kaolin clay slurry containing the well-dispersed clay and chlorite, is then loaded into tankers for shipment to the user.

In another embodiment, if a plant prepares its own kaolin clay slurry for immediate use on the production line, the chlorite can be acidified to provide immediate release of the chlorine dioxide for immediate employment of oxidation/biocidal properties in the slurry. In order to facilitate the immediate release of active chlorine dioxide, an acid could be added to the chlorite solution. The fastest and optimal activation is achieved if the chlorite has a strength of between 200 ppm and 4000 ppm as sodium chlorite. The active chlorine dioxide would then be added to the slurry in an appropriate proportion to achieve the desired biocidal/oxidative effect. For highest efficiency, the pH of kaolin slurries ranges from 6-8.

Other slurries used in pulping that could benefit from treatment with stabilized chlorine dioxide include ground titanium or ground calcium carbonate in aqueous slurry.

At the present time, hydrogen peroxide is commonly used as an oxidant. However, stabilized chlorine dioxide presents several advantages because, unlike peroxide it is compatible with many organic biocides and is not deactivated by the enzyme catalase present in alluvial clays.

The stabilized chlorine dioxide can be used in conjunction with some organic biocides without deactivation of either component. For example, when stabilized chlorine dioxide (concentration to yield 20 to 100 ppm as ClO₂) was added to slurry containing glutaraldehyde (concentration 20 to 200 ppm) it was observed that the glutaraldehyde remained active. Isothiazolone based biocides and bronopol also proved to be compatible with use of stabilized chlorine dioxide. Furthermore, there was evidence that the slow degradation of glutaraldehyde to lactone species in the clay slurry was inhibited by the presence of stabilized chlorine dioxide.

Chlorine dioxide performs the same oxidizing function as hydrogen peroxide as an oxidizing agent to assist in the removal of iron sulphides, grey color and to suppress growth of anaerobic organisms. However, unlike hydrogen peroxide, stabilized chlorine dioxide is not deactivated by catalase enzyme. Rates of stabilized chlorine dioxide in solution used vary between 10 ppm and 200 ppm expressed as chlorine dioxide, depending on the slurry. A small portion of the stabilized chlorine dioxide will be consumed immediately by chemical oxidation reactions with the components/impurities in the slurry, but the majority of the stabilized chlorine dioxide is available for slow release for prevention of bacterial fouling. Calcined kaolins require lower concentrations than hydrous clays, which require amounts of ClO₂ at the higher concentration ranges. When slurries is treated with a high concentration of stabilized chlorine dioxide it has been found that the majority of the activate chlorine dioxide is released slowly over a period of up to 14 days. The addition of acid will enhance release of the active free ClO₂, but this free released chlorine dioxide is expected to have a shorter lifetime than the slurry. Acid-enhanced chlorine dioxide should have a high biocidal potential.

Most beneficial results are obtained at pH of 5-8, though a wide range of 5-9.5 is acceptable under some circumstances.

Materials:

The stabilized chlorine dioxide (as sodium chlorite) was obtained from Zychem Technologies, Ltd. of Sligo, Ireland. Water is the carrier. Sodium chlorite is the stabilized chlorine dioxide used. When amounts are express as to stabilized chlorine dioxide, the amount in % relates to the amount of chlorine dioxide available.

### EXAMPLE 1

To 1000 tons of clay slurry under constant agitation of the slurry containing about 70% weight of kaolin clay solids is added 50 gallons of stabilized chlorine dioxide containing 20% by weight of total chlorine dioxide (or about 32% by weight as expressed as sodium chlorite) using a dosing system to allow gradual addition. After 3 hours the agitation is discontinued and the slurry is transferred to a shipping tanker.

The clay prepared in this manner is ready for addition to pulp in accord with the methods used by the end-user to make paper products.

### EXAMPLE 2

Twenty gallons of stabilized chlorine dioxide containing 20% by weight total available chlorine dioxide is diluted to 1600 gallons in water. To this is slowly added 30 gallons of 25% hydrochloric acid with stirring. After 5-10 minutes the solution is yellow color, indicating the release of chlorine dioxide. This chlorine dioxide solution is then discharged into 1000 tons of clay slurry containing about 70% by weight kaolin clay solids. After stirring the slurry for 2 hours, the slurry is ready to be shipped by rail car.

The amount of time required required for sufficient mixing by agitation of the clay slurry after addition of the stabilized chlorine dioxide solution depends on the clay itself. In the preferred application, the stabilized chlorine dioxide will be dispersed uniformly through the slurry. Usually 1-5 hours will be appropriate.

In example 1, the stabilized chlorine dioxide can be expected to slowly release chlorine dioxide over a period of up to 14 days, and can, therefore, be expected to oxidize organic material for that length of time.

Example 2 relates to the use of acid to facilitate the release of chlorine dioxide. Hence, the biocidal/oxidizing activity of the chlorine dioxide will occur more immediately. This method may be preferred when the slurry is to be used immediately. When the pH of the clay slurry is less than 7.5 (preferably less than 7) the effectiveness of the added stabilized chlorine dioxide would be reliably high. At the present time, only calcined clays have a natural processed pH of 6.5-7. Other clays, including hydrous kaolins and the calcium carbonate clays, have a natural processed pH of over 8.

What we claim is:

1. A method of processing a clay slurry comprising the steps of:
(1) dispersing clay in a slurry containing 40% to 80% clay in water by agitation,
(2) adding to the clay slurry of step 1, while agitation continues, a solution containing stabilized chlorine dioxide,
(c) agitating the resulting solution of step 2 for 1-8 hours.

2. The method of claim 1 wherein the slurry of step 1 contains about 70% clay.

3. Preparing a clay slurry comprising the steps of:
(1) acidifying a solution containing stabilized chorine dioxide with an acid solution in sufficient amounts to provide release of chlorine dioxide to cause a yellow color to the solution in ≦30 minutes,
(2) agitating a clay slurry containing 40% to 80% clay to assure uniform dispersal of clay in the slurry,
(3) adding the solution prepared in step 1 to the solution prepared in step 2 with continuing agitation.

4. The method of claim 3 wherein the acid added is hydrochloric acid.

5. The method of claim 1 wherein the clay in the slurry is a calcined clay.

6. The method of claim 2 wherein the clay in slurry is a calcined clay.

7. The method of claim 1 wherein the clay slurry contains a biocide.

8. The method of claim 3 wherein the clay slurry contains a biocide.
